(19) United States
(12) Patent Application Publication
(10) Pub. No.: US 2026/0252609 A1
(43) Pub. Date: Aug. 27, 2026

(54) METHOD AND SYSTEM FOR GENERATING EMBEDDING VECTORS

(71) Applicant: Sionic AI Inc., Seoul (KR)

(72) Inventors: Woomyoung PARK, Seoul (KR); Yewon LIM, Seoul (KR)

(21) Appl. No.: 19/259,026

(22) Filed: Jul. 3, 2025

(30) Foreign Application Priority Data
Feb. 21, 2025 (KR) 10-2025-0022891

(51) Int. Cl. G06F 16/334; G06F 40/284; G06N 3/0455

(52) U.S. Cl. CPC G06F 16/3347; G06F 40/284; G06N 3/0455

(57) ABSTRACT

A method of generating an embedding vector associated with a specific domain performed by at least one processor, includes acquiring an embedding model pretrained to generate an embedding vector based on a training document set, receiving a query for a retrieval target document set associated with the specific domain, calculating a retrieval weight coefficient associated with a statistical distribution of the query, and generating, through the embedding model, an embedding vector reflecting the calculated retrieval weight coefficient.

### CROSS-REFERENCE TO RELATED APPLICATION

This application claims priority to Korean Patent Application No. 10-2025-0022891, filed in the Korean Intellectual Property Office on Feb. 21, 2025, the entire contents of which are hereby incorporated by reference.

### FIELD

The present disclosure relates to a method of generating an embedding vector associated with a specific domain and a system for the method.

### BACKGROUND

Recent advances in the field of natural language processing include semantic search technology, which returns relevant results based on semantic similarity between a search query and documents rather than relying solely on keyword matching.

To perform semantic search, a pretrained model based on a corpus containing general language data that is not limited to a specific topic may be used, and the pretrained model may be fine-tuned to a specific domain so as to be applied to a particular task.

However, because the pretrained corpus-based model has a considerable size, enormous amounts of training data and training resources are required to set a vast number of parameters, resulting in significant time and cost.

The above information disclosed in the background-art section is merely intended to increase understanding of the background of the present disclosure and may include information that does not constitute related art.

### SUMMARY

The present disclosure provides a method, a system, and a computer-readable recording medium storing a computer program for generating an embedding vector based on a statistical distribution of queries associated with a specific domain so as to solve the problems described above.

The present disclosure may be implemented in various forms including a method, an apparatus (system), or a computer-readable storage medium storing a computer program.

A method of generating an embedding vector associated with a specific domain according to an example of the present disclosure performed by at least one processor may include acquiring an embedding model pretrained to generate an embedding vector based on a training document set, receiving a query for a retrieval target document set associated with the specific domain, calculating a retrieval weight coefficient associated with a statistical distribution of the query, and generating, through the embedding model, an embedding vector reflecting the calculated retrieval weight coefficient.

In some implementations, the calculating the retrieval weight coefficient may include calculating the retrieval weight coefficient based on a total number of the retrieval target document set and a number of retrieval target documents including a word constituting the query.

In some implementations, the calculating the retrieval weight coefficient may include calculating the retrieval weight coefficient based on a log-scale transformed value of a first ratio of a total number of the retrieval target document set to a number of retrieval target documents including a word constituting the query and a log-scale transformed value of a second ratio of a total number of the training document set to a number of training documents including a word constituting the query.

In some implementations, the method further includes calculating the retrieval weight coefficient to reduce importance of the word constituting the query when the log-scale transformed value of the first ratio is less than a preset first threshold and the log-scale transformed value of the second ratio is greater than a preset second threshold.

In some implementations, the method further includes calculating the retrieval weight coefficient to increase importance of the word constituting the query when the log-scale transformed value of the first ratio is greater than the preset second threshold and the log-scale transformed value of the second ratio is less than the preset first threshold.

In some implementations, the method further includes calculating the retrieval weight coefficient to reduce importance of the word constituting the query when the log-scale transformed value of the first ratio is less than the preset first threshold and a difference obtained by subtracting the log-scale transformed value of the first ratio from the log-scale transformed value of the second ratio is greater than a third threshold.

In some implementations, the method further includes calculating the retrieval weight coefficient to increase importance of the word constituting the query when the log-scale transformed value of the first ratio is greater than the preset second threshold and a difference obtained by subtracting the log-scale transformed value of the second ratio from the log-scale transformed value of the first ratio is greater than a third threshold.

In some implementations, the method further includes calculating the retrieval weight coefficient to reduce importance of at least one word from among words constituting the query for which a difference between the log-scale transformed value of the second ratio and the log-scale transformed value of the first ratio is greater than or equal to a fourth threshold.

In some implementations, the generating the embedding vector reflecting the calculated retrieval weight coefficient may include tokenizing the query, substituting each token of the tokenized query with a one-hot vector, and multiplying the substituted one-hot vector by the calculated retrieval weight coefficient and inputting into the embedding model to generate the embedding vector.

In some implementations, the embedding model further may include a sparse autoencoder (SAE), and wherein the generating the embedding vector reflecting the calculated retrieval weight coefficient may include tokenizing the query, calculating a sparse feature vector by inputting the tokenized query into the SAE, masking at least one token from the tokenized query and inputting into the SAE to identify a position associated with the at least one token in the sparse feature vector, and multiplying the calculated retrieval weight coefficient at the identified position to generate the embedding vector.

In some implementations, a non-transitory computer-readable medium storing instructions that, when executed by a processor, cause the processor to perform the method may be provided.

In some implementations, an information processing system may include a memory, and a processor connected to the memory and configured to execute at least one computer-readable program stored in the memory, wherein the at least one program may include instructions configured to acquire an embedding model pretrained to generate an embedding vector based on a training document set, receive a query for a retrieval target document set associated with a specific domain, calculate a retrieval weight coefficient associated with a statistical distribution of the query, and generate, through the embedding model, an embedding vector reflecting the calculated weight coefficient.

According to various aspects of the present disclosure, because the embedding vector associated with the specific domain may be effectively generated without performing fine-tuning on a large-scale pretrained model, semantic search associated with the specific domain may be effectively performed.

The effects of the present disclosure are not limited to the effects mentioned above, and other effects not mentioned will be clearly understood by those of ordinary skill in the art from the description in the claims.

### BRIEF DESCRIPTION OF THE DRAWINGS

Embodiments of the present disclosure will be described below with reference to the accompanying drawings, in which like reference numerals indicate like elements; however, the present disclosure is not limited thereto.

FIG. 1 is a diagram illustrating an embedding vector generation system according to an example of the present disclosure.

FIG. 2 is an overview diagram illustrating a configuration in which an information processing system is connected so as to be able to communicate with a plurality of user terminals to provide embedding vector generation and semantic search services using an embedding model according to an example of the present disclosure.

FIG. 3 is a block diagram illustrating internal configurations of a user terminal and an information processing system according to an example of the present disclosure.

FIG. 4 is a diagram illustrating calculation of a statistical distribution of queries included in a retrieval target document set associated with a specific domain according to an example of the present disclosure.

FIG. 5 is a diagram illustrating a tokenized query reflecting a calculated retrieval weight coefficient according to an example of the present disclosure.

FIG. 6 is a diagram illustrating a method of applying a calculated retrieval weight coefficient to an embedding model according to an example of the present disclosure.

FIG. 7 is a sequence diagram illustrating a method of generating an embedding vector associated with a specific domain according to an example of the present disclosure.

FIG. 8 is a sequence diagram illustrating a method of generating an embedding vector reflecting a calculated weight coefficient according to an example of the present disclosure.

FIG. 9 is a diagram illustrating a method of applying a calculated retrieval weight coefficient to an embedding model according to an example of the present disclosure.

Embodiments of the present disclosure will be described below with reference to the accompanying drawings, in which like reference numerals indicate like elements; however, the present disclosure is not limited thereto.

### DETAILED DESCRIPTION

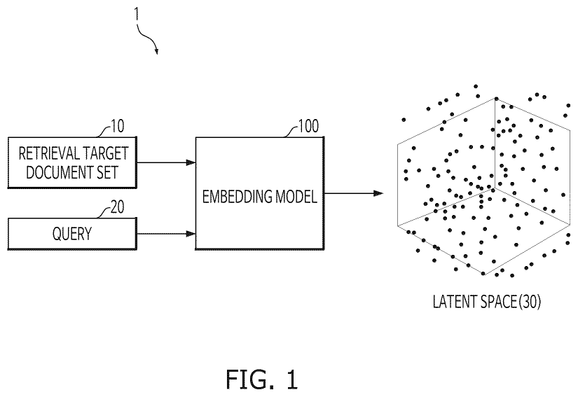

FIG. 1 is a diagram illustrating, in outline, an embedding vector generation system 1 according to an example of the present disclosure.

Referring to FIG. 1, the embedding vector generation system 1 may be a system that generates an embedding vector for converting text data from a high-dimensional space to a low-dimensional vector space, for example, a latent space 30.

The embedding vector generation system 1 may include a pretrained embedding model 100. The embedding model 100 may be a model pretrained to locate, in the latent space 30, a training document set, for example, a corpus. Here, the training document set may be a set of text data not limited to any particular topic or domain, but the present disclosure is not limited thereto.

In the present disclosure, the embedding vector generation system 1 may apply the pretrained embedding model 100 to a specific domain without fine-tuning. That is, the embedding vector generation system 1 may apply the embedding model 100, which is trained based on the training document set, to a specific domain corresponding to an untrained particular task and may process the specific task without fine-tuning.

The embedding vector generation system 1 may receive a retrieval target document set 10 associated with a specific domain, for example, a finance domain, and a query 20 associated with the retrieval target document set 10. The embedding model 100 may embed the retrieval target document set 10 and the query 20 in the latent space 30. The embedding vector generation system 1 may generate an embedding vector based on a statistical distribution of the query 20 within the retrieval target document set 10.

The embedding vector generation system 1 may determine similarity, for example, cosine similarity or similarity based on Euclidean distance, between embedding vectors generated by the embedding model 100 and may determine at least one document similar to the query 20.

In an example, when the embedding vector generation system 1 calculates the statistical distribution of the received query 20, the embedding vector generation system 1 may generate an embedding vector through the embedding model 100 based on the statistical distribution of the query 20 in the retrieval target document set 10 and/or in the training document set.

In the present disclosure, although the embedding vector generation system 1 is described as generating an embedding vector based on text data, the present disclosure is not limited thereto, and the embedding vector generation system 1 may receive another type of data and generate an embedding vector.

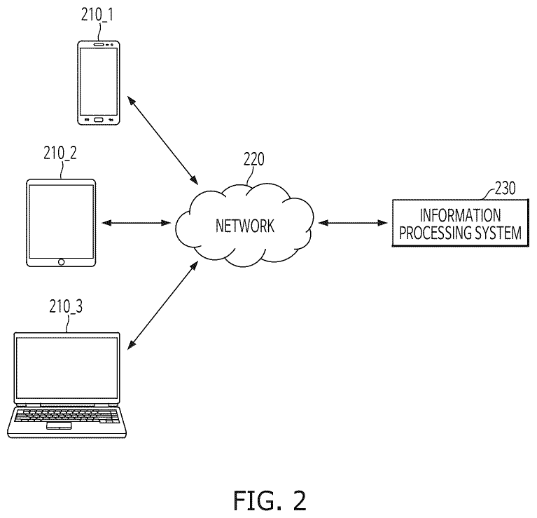

FIG. 2 is an overview diagram illustrating a configuration in which an information processing system 230 is connected so as to be able to communicate with a plurality of user terminals 210_1, 210_2, and 210_3 in order to provide embedding vector generation and semantic search services using an embedding model according to an example of the present disclosure.

Referring to FIG. 2, the information processing system 230 may include a system or systems capable of generating embedding vectors based on a specific domain. In an example, the information processing system 230 may include one or more server devices and/or databases or one or more distributed computing devices and/or distributed databases based on a cloud computing service capable of storing, providing, and executing computer-executable programs and data related to generation of embedding vectors based on a specific domain. For example, the information processing system 230 may include separate systems, such as servers, for generating embedding vectors.

The embedding vector generation and semantic search services based on the generated embedding vectors provided by the information processing system 230 may be provided to users through applications installed on respective ones of the plurality of user terminals 210_1, 210_2, and 210_3.

The plurality of user terminals 210_1, 210_2, and 210_3 may communicate with the information processing system 230 through a network 220. The network 220 may be configured to enable communication between the plurality of user terminals 210_1, 210_2, and 210_3 and the information processing system 230. Depending on the installation environment, the network 220 may be configured as a wired network, such as Ethernet, a wired home network (power-line communication), telephone-line communication equipment, or RS-serial communication, a wireless network, such as a mobile communication network, WLAN, Wi-Fi, Bluetooth, or ZigBee, or a combination thereof. The communication method is not limited, and the network 220 may include short-range wireless communication between user terminals 210_1, 210_2, and 210_3 as well as communication methods using a communication network included in the network 220.

In FIG. 2, a mobile-phone terminal 210_1, a tablet terminal 210_2, and a PC terminal 210_3 are illustrated as examples of the user terminals, but the present disclosure is not limited thereto, and the user terminals 210_1, 210_2, and 210_3 may be any computing devices capable of wired and/or wireless communication and capable of installing and executing an application. For example, the user terminal may include a smartphone, a mobile phone, a navigation device, a computer, a notebook, a digital-broadcasting terminal, a personal digital assistant, a portable multimedia player, a tablet PC, a game console, a wearable device, an Internet-of-Things device, a virtual-reality device, or an augmented-reality device. Although FIG. 2 illustrates three user terminals, the present disclosure is not limited thereto, and a different number of user terminals may be configured to communicate with the information processing system 230 through the network 220.

In an example, each of the user terminals 210_1, 210_2, and 210_3 may receive information or data from another user terminal or may transmit information or data to another user terminal through the network 220.

Although FIG. 2 illustrates the information processing system 230 as a device separate from the user terminals 210_1, 210_2, and 210_3, the present disclosure is not limited thereto, and the information processing system 230 may be integrally implemented with the user terminals 210_1, 210_2, and 210_3.

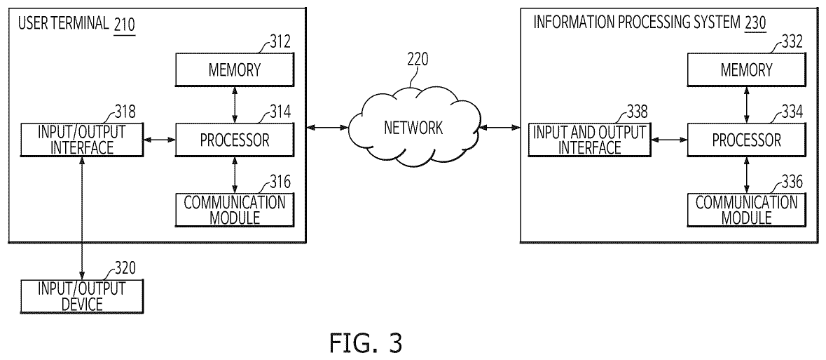

FIG. 3 is a block diagram illustrating internal configurations of a user terminal 210 and an information processing system 230 according to an example of the present disclosure.

The user terminal 210 may denote any computing device capable of executing an application or a web browser and capable of wired/wireless communication and may include, for example, the mobile-phone terminal 210_1, the tablet terminal 210_2, or the PC terminal 210_3. Referring to FIG. 3, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to communicate information and/or data through the network 220 using their respective communication modules 316 and 336. In addition, an input/output device 320 may be configured to input information and/or data to the user terminal 210 or to output information and/or data generated from the user terminal 210 through the input/output interface 318.

The memories 312 and 332 may include any non-transitory computer-readable recording medium. According to an example, the memories 312 and 332 may include a permanent mass-storage device, such as read-only memory, a disk drive, a solid-state drive, or flash memory. In another example, a permanent mass-storage device, such as read-only memory, a solid-state drive, flash memory, or a disk drive, may be included as a separate permanent storage device distinct from the memory and may be included in the user terminal 210 or the information processing system 230. An operating system and at least one program code may be stored in the memories 312 and 332.

Such software components may be loaded from a computer-readable recording medium distinct from the memories 312 and 332. The separate computer-readable recording medium may include a recording medium directly connectable to the user terminal 210 or the information processing system 230, such as a floppy drive, a disk, a tape, a DVD/CD-ROM drive, or a memory card. In another example, the software components may be loaded into the memories 312 and 332 through the communication modules 316 and 336 rather than from a computer-readable recording medium. For example, at least one program may be loaded into the memories 312 and 332 based on files provided through the network 220 by developers or by a file-distribution system that distributes installation files of an application.

The processors 314 and 334 may be configured to process instructions of a computer program by performing basic arithmetic, logical, and input/output operations. The instructions may be provided to the processors 314 and 334 by the memories 312 and 332 or by the communication modules 316 and 336. For example, the processors 314 and 334 may execute instructions received according to program code stored in a recording device, such as the memories 312 and 332.

The communication modules 316 and 336 may provide configurations or functions for communication between the user terminal 210 and the information processing system 230 through the network 220 and may provide configurations or functions for the user terminal 210 and/or the information processing system 230 to communicate with another user terminal or another system, for example, a separate cloud system. For example, a request or data generated according to program code stored in the memory 312 by the processor 314 of the user terminal 210 may be transmitted to the information processing system 230 through the network 220 under control of the communication module 316. Conversely, a control signal or command provided under control of the processor 334 of the information processing system 230 may be received by the user terminal 210 through the communication module 316 via the communication module 336 and the network 220.

The input/output interface 318 may be means for interfacing with the input/output device 320. In an example, the input device may include a camera having an audio sensor and/or an image sensor, a keyboard, a microphone, a mouse, or the like, and the output device may include a display, a speaker, or a haptic-feedback device. In another example, the input/output interface 318 may be means for interfacing with a device in which configurations or functions for input and output are integrated into a single device, such as a touchscreen. For example, when the processor 314 of the user terminal 210 processes instructions of a computer program loaded into the memory 312, a service screen composed using information and/or data provided by the information processing system 230 or by another user terminal may be displayed through the input/output interface 318 on the display. Although FIG. 3 illustrates that the input/output device 320 is not included in the user terminal 210, the present disclosure is not limited thereto, and the input/output device 320 may be configured as a single device with the user terminal 210. In addition, the input/output interface 338 of the information processing system 230 may be means for interfacing with a device for input or output that is connected to or included in the information processing system 230. Although FIG. 3 illustrates the input/output interfaces 318 and 338 as elements separate from the processors 314 and 334, the present disclosure is not limited thereto, and the input/output interfaces 318 and 338 may be configured to be included in the processors 314 and 334.

The user terminal 210 and the information processing system 230 may include more components than the components illustrated in FIG. 3; however, it is unnecessary to explicitly illustrate most conventional components. In an example, the user terminal 210 may be implemented to include at least some of the above-described input/output devices 320. In addition, the user terminal 210 may further include other components such as a transceiver, a global positioning-system module, a camera, various sensors, or a database. For example, when the user terminal 210 is a smartphone, the user terminal 210 may include components generally included in a smartphone; for example, various components such as an accelerometer, a gyro sensor, a microphone module, a camera module, various physical buttons, buttons using a touch panel, input/output ports, and a vibrator may be further included in the user terminal 210.

While a program for applications including embedding-vector generation and semantic-search services based on the generated embedding vectors is running, the processor 314 may receive text, images, videos, voice, and/or actions input or selected through input devices, such as a touchscreen, a keyboard, an audio sensor, and/or an image sensor including a camera or a microphone, which are connected to the input/output interface 318, and may store the received text, images, videos, voice, and/or actions in the memory 312 or may provide the text, images, videos, voice, and/or actions to the information processing system 230 through the communication module 316 and the network 220.

The processor 314 of the user terminal 210 may manage, process, and/or store information and/or data received from the input/output device 320, another user terminal, the information processing system 230, and/or a plurality of external systems. The information and/or data processed by the processor 314 may be provided to the information processing system 230 through the communication module 316 and the network 220. The processor 314 of the user terminal 210 may transmit information and/or data to the input/output device 320 through the input/output interface 318 so as to output the information and/or data. For example, the processor 314 may display the received information and/or data on a screen of the user terminal 210.

The processor 334 of the information processing system 230 may manage, process, and/or store information and/or data received from the plurality of user terminals 210 and/or a plurality of external systems. The information and/or data processed by the processor 334 may be provided to the user terminal 210 through the communication module 336 and the network 220. Hereinafter, the “processor” may denote the processor of the information processing system or the processor of the user terminal.

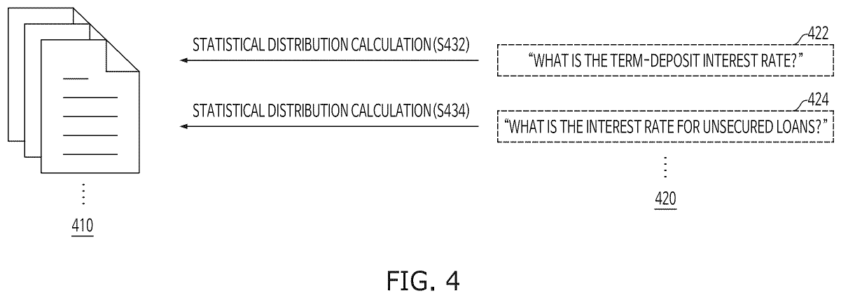

FIG. 4 is a diagram illustrating calculation of a statistical distribution of queries included in a retrieval target document set 410 associated with a specific domain according to an example of the present disclosure.

Referring to FIG. 4, after acquiring a pretrained embedding model configured to generate an embedding vector based on a training document set, the processor may receive the retrieval target document set 410 associated with the specific domain. In an example, the specific domain may be a finance domain, but the present disclosure is not limited thereto.

The processor may receive a query 420 for the retrieval target document set 410 associated with the specific domain. For example, the processor may receive a first query 422, “What is the term-deposit interest rate?”, and a second query 424, “What is the interest rate for unsecured loans?”.

The processor may calculate statistical distributions of the queries 420 for the retrieval target document set 410 associated with the specific domain (S432, S434). For example, the processor may calculate a statistical distribution of the first query 422 (S432) and may calculate a statistical distribution of the second query 424 (S434) in the retrieval target document set 410. At this time, the processor may tokenize the first query 422 and the second query 424 into units of words or syllables and may calculate the statistical distribution of the retrieval target document set 410.

When calculating the statistical distribution of the queries for the retrieval target document set 410 associated with the specific domain, the processor may calculate a retrieval weight coefficient. The retrieval weight coefficient may be applied to each token of the tokenized query and may be an element for increasing or decreasing importance of each token of the tokenized query so that the pretrained embedding model configured to generate an embedding vector based on a general document set generates an embedding vector suited (or custumed) to the specific domain. For example, in a general document set, because occurrences of the word “interest” are rare, the word may be treated as an important word, whereas in a finance domain, because occurrences of the word “interest” are frequent, the word may be treated as a word of low importance.

In an example, the processor may use an inverse-document-frequency value, which is a statistical indicator for evaluating importance of a specific word in a document set, as the retrieval weight coefficient. The processor may calculate the retrieval weight coefficient based on Equation 1 using a total number TD 1 of a collection D1 of the retrieval target document set and a number DF1 of retrieval target documents including a specific word Qi constituting the query. In an example, to prevent the denominator from becoming “0,” the processor may add 1 to the denominator. However, the present disclosure is not limited thereto.

$$IDF ( Qi , D 1 ) = log ( TD 1 / DF 1 ) \qquad [ Equation 1 ]$$

Here, IDF(Qi, D1) may be a value obtained by converting to a log scale a ratio of the total number TD1 of the collection D1 of the retrieval target document set to the number DF1 of retrieval target documents including the specific word Qi constituting the query.

The IDF(Qi, D1) outputs a larger value as the number DF1 of retrieval target documents including the specific word Qi decreases and outputs a smaller value as the number DF1 increases. Accordingly, as the number DF1 of retrieval target documents including the specific word Qi decreases in the collection D1 of the retrieval target document set, the processor may determine that importance of the specific word Qi is high. Therefore, because importance of a word in the specific domain may be determined, semantic search for the specific domain may be effectively performed.

Hereinafter, a method of calculating the retrieval weight coefficient in consideration of both the retrieval target document set and the training document set will be described.

The processor may calculate retrieval weight coefficients for the retrieval target document set and the training document set used when training the embedding model. The processor may calculate the retrieval weight coefficient based on the log-scale transformed value IDF(Qi, D1) of the first ratio of the total number TD1 of the collection D1 of the retrieval target document set to the number DF1 of retrieval target documents including the specific word Qi constituting the query and the log-scale transformed value IDF(Qi, D2) of the second ratio of the total number TD2 of the collection D2 of the training document set to a number DF2 of training documents including the specific word Qi constituting the query.

In a first example, the processor may calculate the retrieval weight coefficient SWC in accordance with Equation 2 based on the log-scale transformed value IDF(Qi, D1) of the first ratio and the log-scale transformed value IDF(Qi, D2) of the second ratio.

$$SWC = IDF ( Qi , D 1 ) / IDF ( Qi , D 2 ) \qquad [ Equation 2 ]$$

In a second example, when the log-scale transformed value IDF(Qi, D1) of the first ratio is less than a preset first threshold TH1 and the log-scale transformed value IDF(Qi, D2) of the second ratio is greater than a preset second threshold TH2, the processor may calculate the retrieval weight coefficient so as to reduce importance of the corresponding word constituting the query. Here, the first threshold TH1 is less than or equal to the second threshold TH2, and the processor may multiply a value less than 1 by the calculated retrieval weight coefficient to reduce weight of the corresponding word. The value less than 1 may be IDF(Qi, D 1)/IDF(Qi, D2).

Conversely, when the log-scale transformed value IDF(Qi, D1) of the first ratio is greater than the second threshold TH2 and the log-scale transformed value IDF(Qi, D2) of the second ratio is less than the first threshold TH1, the processor may calculate the retrieval weight coefficient so as to increase importance of the corresponding word constituting the query. In this case, the processor may multiply a value greater than 1 to increase weight of the corresponding word.

In a third example, when the log-scale transformed value IDF(Qi, D1) of the first ratio is less than the first threshold TH1 and a value obtained by subtracting the log-scale transformed value IDF(Qi, D1) of the first ratio from the log-scale transformed value IDF(Qi, D2) of the second ratio is greater than a third threshold TH3, the processor may calculate the retrieval weight coefficient so as to reduce importance of the corresponding word constituting the query. In this case, the processor may multiply a value less than 1 by the calculated retrieval weight coefficient to reduce weight of the corresponding word. The value less than 1 may be IDF(Qi, D1)/IDF(Qi, D2).

Conversely, when the log-scale transformed value IDF(Qi, D1) of the first ratio is greater than the second threshold TH2 and a value obtained by subtracting the log-scale transformed value IDF(Qi, D2) of the second ratio from the log-scale transformed value IDF(Qi, D1) of the first ratio is greater than the third threshold TH3, the processor may calculate the retrieval weight coefficient so as to increase importance of the corresponding word constituting the query. In this case, the processor may multiply a value greater than 1 to increase weight of the corresponding word. However, this disclosure is not limited thereto.

In a fourth example, the processor may calculate the retrieval weight coefficient so as to reduce importance of at least one word from among words constituting the query for which a difference between the log-scale transformed value IDF(Qi, D2) of the second ratio and the log-scale transformed value IDF(Qi, D1) of the first ratio is greater than or equal to a fourth threshold TH4. In this case, when the difference between the log-scale transformed values IDF(Qi, D2) and IDF(Qi, D1) is greater than 0, the processor may multiply a value less than 1, whereas when the difference is less than 0, the processor may multiply a value greater than 1.

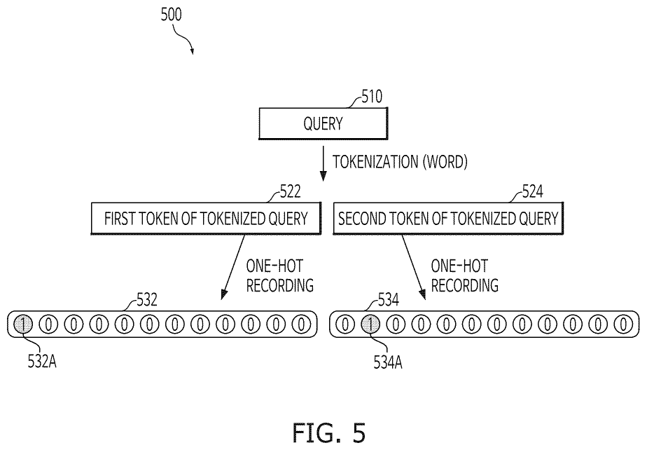

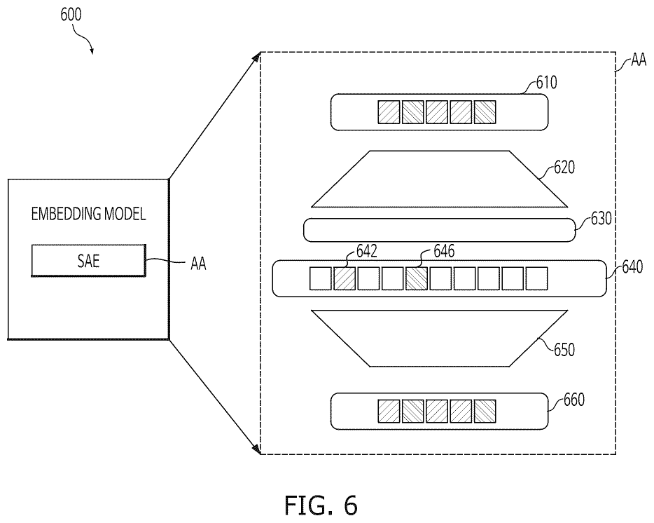

FIGS. 5 and 6 are diagrams illustrating a process of generating, through the embedding model, an embedding vector reflecting the calculated retrieval weight coefficient. FIG. 5 is a diagram 500 illustrating a tokenized query reflecting a calculated retrieval weight coefficient according to an example of the present disclosure.

Referring to FIG. 5, the processor may generate, through the embedding model, an embedding vector reflecting the calculated retrieval weight coefficient.

The processor may tokenize the query 510. Specifically, the processor may separate the query 510 into tokens, for example, words. For example, the processor may generate a first token 522 of the tokenized query and a second token 524 of the tokenized query.

The processor may substitute each token of the tokenized query with a one-hot vector. For example, the processor may substitute the first token 522 of the tokenized query with a one-hot vector 532 and may substitute the second token 524 of the tokenized query with a one-hot vector 534. The one-hot vector may correspond to a representation in which only one value is 1 and all other values are 0.

The processor may multiply the calculated retrieval weight coefficient by the substituted one-hot vector and may input the result into the embedding model to generate the embedding vector. For example, when the tokenized query is retrieved in the retrieval target document set, the processor may multiply the calculated retrieval weight coefficient by the “1” value (for example, 532 A and 534 A) of the one-hot vector corresponding to each token of the query. Accordingly, the retrieval weight coefficient may be reflected in the embedding vector.

FIG. 6 is a diagram illustrating a method of applying the calculated retrieval weight coefficient to the embedding model according to an example of the present disclosure.

Referring to FIG. 6, an embedding model 600 is a configuration for generating an embedding vector and may include a sparse autoencoder AA (SAE). The SAE may be a neural network that constrains most activation values in a hidden layer of an encoder to 0.

The SAE AA may include an encoder matrix 620 for mapping an activated vector 610, which is received as input data, to a latent space. The SAE AA may add a bias to output data of the encoder matrix 620 and may apply an activation function 630. The SAE AA may include a sparse feature vector 640, which may be a feature vector for setting most activation values to 0. The SAE AA may generate a decoder matrix 650 for restoring original data and a restored activated vector 660.

To apply the calculated retrieval weight coefficient to the embedding model 600, the processor may tokenize the query and may input the tokenized query into the SAE to calculate the sparse feature vector 640. For example, the processor may calculate the sparse feature vector 640 associated with a specific tokenized query. The SAE AA may perform the decoder matrix 650 for restoring original data and generate the restored activated vector 660.

Next, the processor may mask a specific token (or at least one token) from a previously processed query and input the masked query into the SAE (AA) to identify positions (642, 646) associated with the token in the sparse feature vector. The processor may generate an embedding vector by multiplying the retrieval weight coefficient calculated for the identified positions. In other words, after the processor inputs the tokenized query into the SAE (AA) to generate a sparse feature vector, the processor may mask the specific token (including at least some tokens of the query) and input the masked query into the SAE (AA) to identify, within the sparse feature vector, the features (642, 646) resulting from masking. Specifically, the processor may identify the positions through portions that become inactive in the sparse feature vector (640), which is generated by masking the specific token among the activated sparse features of the sparse feature vector corresponding to the tokenized query. The processor may multiply the retrieval weight coefficient at the identified positions to generate a domain-specific embedding vector.

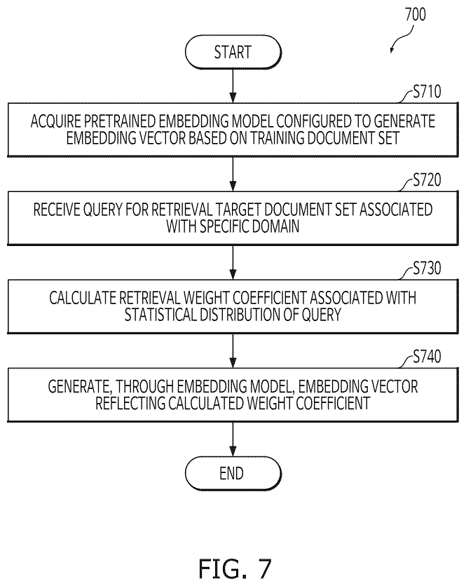

FIG. 7 is a sequence diagram illustrating a method 700 of generating an embedding vector associated with a specific domain according to an example of the present disclosure.

In step S710, the processor may acquire a pretrained embedding model configured to generate an embedding vector based on a training document set.

In step S720, the processor may receive a query for the retrieval target document set associated with the specific domain.

In step S730, the processor may calculate a retrieval weight coefficient associated with a statistical distribution of the query.

In step S740, the processor may generate, through the embedding model, an embedding vector reflecting the calculated retrieval weight coefficient.

The processor may consider only the retrieval target document set; the processor may calculate the retrieval weight coefficient based on the total number of the retrieval target document set and the number of documents of the retrieval target document set that include a word constituting the query. In addition, the processor may consider both the retrieval target document set and the training document set, and detailed descriptions thereof have been omitted above.

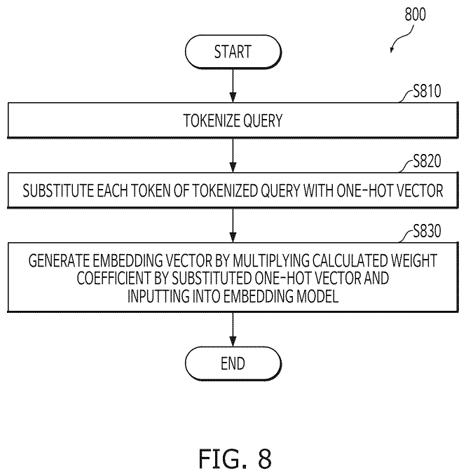

FIG. 8 is a sequence diagram illustrating a method 800 of generating an embedding vector reflecting a calculated weight coefficient according to an example of the present disclosure.

In step S810, the processor may tokenize the query. The processor may separate the query into tokens, for example, words, and the tokenized query may include a plurality of tokens.

In step S8320, the processor may substitute each token of the tokenized query with a one-hot vector.

In step S830, the processor may generate an embedding vector by multiplying the calculated weight coefficient by the substituted one-hot vector and inputting the result into the embedding model.

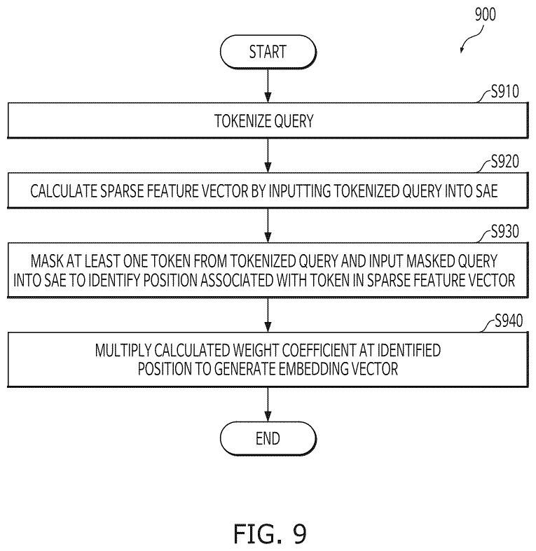

FIG. 9 is a diagram illustrating a method of applying the calculated retrieval weight coefficient to the embedding model according to an example of the present disclosure.

In step S910, the processor may tokenize the query. Each token of the tokenized query may include a word, but the present disclosure is not limited thereto.

In step S920, the processor may calculate a sparse feature vector by inputting the tokenized query into the SAE.

In step S930, the processor may identify, by masking at least some tokens of the tokenized query and inputting the masked query into the SAE, a position associated with the tokens in the sparse feature vector.

In step S940, the processor may generate the embedding vector by multiplying the calculated retrieval weight coefficient at the identified position.

What is claimed is:

1. A method of generating at least one embedding vector performed by an apparatus comprising at least one processor, the method comprising:
acquiring an embedding model pretrained to generate at least one embedding vector based on a training document set;
receiving a query for a retrieval target document set associated with a specific domain;
calculating, based on a statistical distribution of the specific domain, a retrieval weight coefficient associated with a statistical distribution of the query;
generating, through the embedding model, an embedding vector reflecting the calculated retrieval weight coefficient, wherein the generated embedding vector is associated with the specific domain; and
outputting, based on the generated embedding vector, a response associated with the query.

2. The method as claimed in claim 1, wherein the calculating the retrieval weight coefficient comprises:
calculating the retrieval weight coefficient based on a total number of the retrieval target document set and a number of retrieval target documents including a word constituting the query.

3. The method as claimed in claim 1, wherein the calculating the retrieval weight coefficient comprises:
calculating the retrieval weight coefficient based on:
a log-scale transformed value of a first ratio of a total number of the retrieval target document set to a number of retrieval target documents including a word constituting the query; and
a log-scale transformed value of a second ratio of a total number of the training document set to a number of training documents including a word constituting the query.

4. The method as claimed in claim 3, wherein the calculating the retrieval weight coefficient comprises:
calculating the retrieval weight coefficient to reduce importance of the word constituting the query based on the log-scale transformed value of the first ratio being less than a preset first threshold and the log-scale transformed value of the second ratio being greater than a preset second threshold.

5. The method as claimed in claim 3, wherein the calculating the retrieval weight coefficient comprises:
calculating the retrieval weight coefficient to increase importance of the word constituting the query based on the log-scale transformed value of the first ratio being greater than a preset second threshold and the log-scale transformed value of the second ratio being less than a preset first threshold.

6. The method as claimed in claim 4, wherein the calculating the retrieval weight coefficient comprises:
calculating the retrieval weight coefficient to reduce importance of the word constituting the query based on the log-scale transformed value of the first ratio being less than the preset first threshold and a difference obtained by subtracting the log-scale transformed value of the first ratio from the log-scale transformed value of the second ratio being greater than a third threshold.

7. The method as claimed in claim 5, wherein the calculating the retrieval weight coefficient comprises:
calculating the retrieval weight coefficient to increase importance of the word constituting the query based on the log-scale transformed value of the first ratio being greater than the preset second threshold and a difference obtained by subtracting the log-scale transformed value of the second ratio from the log-scale transformed value of the first ratio being greater than a third threshold.

8. The method as claimed in claim 3, wherein the calculating the retrieval weight coefficient comprises:
calculating the retrieval weight coefficient to reduce importance of at least one word from among words constituting the query for which a difference between the log-scale transformed value of the second ratio and the log-scale transformed value of the first ratio is greater than or equal to a fourth threshold.

9. The method as claimed in claim 1, wherein the generating the embedding vector reflecting the calculated retrieval weight coefficient comprises:
tokenizing the query;
substituting each token of the tokenized query with a one-hot vector; and
multiplying the substituted one-hot vector by the calculated retrieval weight coefficient and inputting into the embedding model to generate the embedding vector.

10. The method as claimed in claim 1, wherein the embedding model further comprises a sparse autoencoder (SAE), and
wherein the generating the embedding vector reflecting the calculated retrieval weight coefficient comprises:
tokenizing the query;
calculating a sparse feature vector by inputting the tokenized query into the SAE;
masking at least one token from the tokenized query and inputting into the SAE to identify a position associated with the at least one token in the sparse feature vector; and
multiplying the calculated retrieval weight coefficient at the identified position to generate the embedding vector.

11. A non-transitory computer-readable medium storing instructions that, when executed by a processor, cause the processor to perform the method of claim 1.

12. An information processing system comprising:
a memory; and
a processor coupled to the memory and configured to execute at least one computer-readable program stored in the memory,
wherein the at least one program comprises instructions, and wherein the instructions, executed by the processor, are configured to cause the information processing system to:
acquire an embedding model pretrained to generate at least one embedding vector based on a training document set,
receive a query for a retrieval target document set associated with a specific domain,
calculate, based on a statistical distribution of the specific domain, a retrieval weight coefficient associated with a statistical distribution of the query,
generate, through the embedding model, an embedding vector reflecting the calculated retrieval weight coefficient, wherein the generated embedding vector is associated with the specific domain, and
output, based on the generated embedding vector, a response associated with the query.
